(19) United States
(12) Patent Application Publication
(10) Pub. No.: US 2008/0126231 A1
(43) Pub. Date: May 29, 2008

(54) System and Method for Evaluating a Security Traders Performance

(76) Inventor: Hernan R. Santiesteban, Milwaukee, WI (US)

Correspondence Address: WHITE-WELKER & WELKER, LLC, P.O. BOX 199, CLEAR SPRING, MD, 21722-0199, US

(21) Appl. No.: 11/535,095

(22) Filed: Sep. 26, 2006

(51) Int. Cl. G06Q 40/00

(52) U.S. Cl. 705/35

(57) ABSTRACT

The present invention is a method for evaluating one or many security trader's performance using technical analysis. The method of the present invention provides for the application of mathematically definable metrics by establishing a correspondence between an account balance and price while and at the same time creating a correspondence between volume and total cost basis amongst others. For a given period of time, it is possible to create progress charts to which analysis tools may be applied. This is accomplished by inputting the securities historical data related to volume and price over the course of a given time frame. With respect to volume, several metrics may be correlated: such as a trader's total transacted share volume; the percentage of a trader's capital currently invested; and the total cost basis dollar value.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a method for evaluating a security trader's performance. More specifically the present invention relates to the utilization of technical analysis techniques to evaluate the past performance of a one or may securities traders.

### BACKGROUND OF THE INVENTION

Traders have used technical analysis to analyze the performance of a security. However, this methodology has not been applied to the trader's performance. Traders have been evaluated based on simple statistics and comparisons to existing benchmarks. For example comparison of a trader or fund's performance to an index such as the S&P 500 or Russell 2000 are well known in the prior art. Additionally, evaluation based solely on the trader's return on investment (ROI) and the use of simple metrics such as percent gained or lost involving trivial bar chart comparisons are also well known as are diversification levels based on pie chart industry divisions.

The present invention improves upon these by incorporating many standard security analysis tools into the analysis of a trader or fund's performance. Thereby not only allowing for detailed measurements of performance, but allowing for new insights into trading patterns and errors that may have not otherwise been detectable. These tools allow for this insight by providing detailed graphical evidence of performance patterns in a familiar format.

Technical analysis is traditionally associated with the evaluation of a securities' performance but it has never been adapted to measure or evaluate a trader's performance. Other have developed methods for measuring a trader or analyst's performance, but nothing taught in the prior art is accurate or sufficient.

For example, U.S. Pat. No. 6,510,419 entitled “Security analyst performance tracking and analysis system and method” issued to Gatto on Jan. 21, 2003 teaches a system and method for measuring, analyzing, and tracking the past performance of security analysts' earnings estimates and recommendations. A database containing historical information pertaining to analyst earnings estimates and recommendations is downloaded into the system. Pre-calculated data values are also added to the database including adjustment factors a single or set of analysts based upon their historical earnings estimates as compared to actual earnings estimates over time, and other user-defined performance analysis set parameters and metrics. A weighting factor may also be calculated for a set of analysts based upon factors such as the recency of an analyst's earnings estimates. Using these adjustment and weighting factors and each analyst's actual earnings estimate, a custom composite estimate may be derived. A front-end graphical user interface (GUI) is used to view analyst historical data either as raw data or, by using a data visualization technique, as a graph or chart. The GUI allows a user to choose from a multitude of predetermined analysis parameters and metrics or to define his own parameters and metrics for calculation and visualization. A user may also, in similar manner, use a GUI to choose parameters and metrics to analyze and display the historical profitability of analysts' recommendations over a plurality of time periods.

U.S. Pat. No. 6,370,516 entitled “Computer based device to report the results of codified methodologies of financial advisors applied to a single security or element” issued to Reese on Apr. 9, 2002 teaches a computer apparatus to automatically generate a display or report containing the result for a plurality of investment advisor methodologies for one specific security at a time.

One shortcoming of the related systems taught by the prior art is that they are limited to the number of securities to which they can be applied.

U.S. Pat. No. 5,909,669 entitled “System and method for generating a knowledge worker productivity assessment” issued to Havens on Jun. 1, 1999 teaches a knowledge worker productivity assessment system includes a database containing survey data generated using a knowledge worker productivity assessment framework. A benchmark database contains benchmark values. A retriever is coupled to the databases to retrieve selected survey data and benchmark values. A calculator is coupled to the retriever and generates a comparison value using the selected survey data. A realtor compares the comparison value to a selected benchmark value to generate a knowledge worker productivity assessment.

U.S. Patent Application 20020022988 entitled “System, method and computer readable medium containing instructions for evaluating and disseminating securities analyst performance information” published on Feb. 21, 2002 to Columbus, et al. teaches that an analyst's performance is evaluated by utilizing information pertaining to at least one revision issued by the analyst involving at least one investment. This evaluation includes determining a conditional performance score indicative of the analyst's performance relative to other investors. The performance score is determined at least in part by considering an average historical performance of the investment, following the revision. In addition, the performance score is also determined using a historical consistency of the analyst's performances with respect to revisions involving the investment, and a number of revisions made by the analyst. Then, the performance score may be adjusted according to one or more adjustments, including adjustments for accentuating a number of issued revisions and a return amount, to generate a final performance score.

### SUMMARY OF THE INVENTION

In accordance with the present invention system and method is provided which overcomes the aforementioned problems of the prior art. The present invention is a method for evaluating a security trader's performance using technical analysis. Technical analysis is traditionally associated with the evaluation of a securities' performance. The present invention applies technical analysis to a trader's performance. The method of the present invention provides for the application of mathematically definable metrics by establishing a correspondence between an account balance and price while and at the same time creating a correspondence between volume and the total cost basis. For a given period of time, it is possible to create progress charts to which analysis tools may be applied.

In the present invention, technical analysis techniques used to chart the past performance of securities are used to evaluate the past performance of a securities trader. Indicators such as volume, simple and exponential moving averages, relative strength, moving average convergence and divergence, stochastic, Fibonacci retracements, Bollinger bands, and others are traditionally applied to the analysis of a security. This is accomplished by inputting the securities historical data related to volume and price over the course of a given time frame. After inputting this data, charts in forms such as OHLC, Candlestick, logarithmic and others are generated. These charts provide information such as support, resistance, trends and various chart patterns.

It is therefore an objective of the present invention to provide a system and method for evaluating a security trader's performance using technical analysis.

It is another objective of the present invention to allow for detailed measurements of performance, whereby new insights into trading patterns and errors that may have not otherwise been detectable through the use of complex mathematical formulas which generate graphical objective evidence to these performance patterns.

It is yet another objective of the present invention to improve upon a system currently used for the analysis of securities performance thus not requiring any significant learning of new skills or techniques.

It still another objective of the present invention to provide a system which is flexible for scaleable use so that it may be used by a single trader, multiple traders, or single or multiple funds.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a wire frame drawing of the graphical user interface illustrating the trading performance of an agent or broker;

FIG. 2 is a chart illustrating the output of the system of the present invention and several possible performance measurements; and

FIG. 3 is a flow chart illustrating the method of use of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

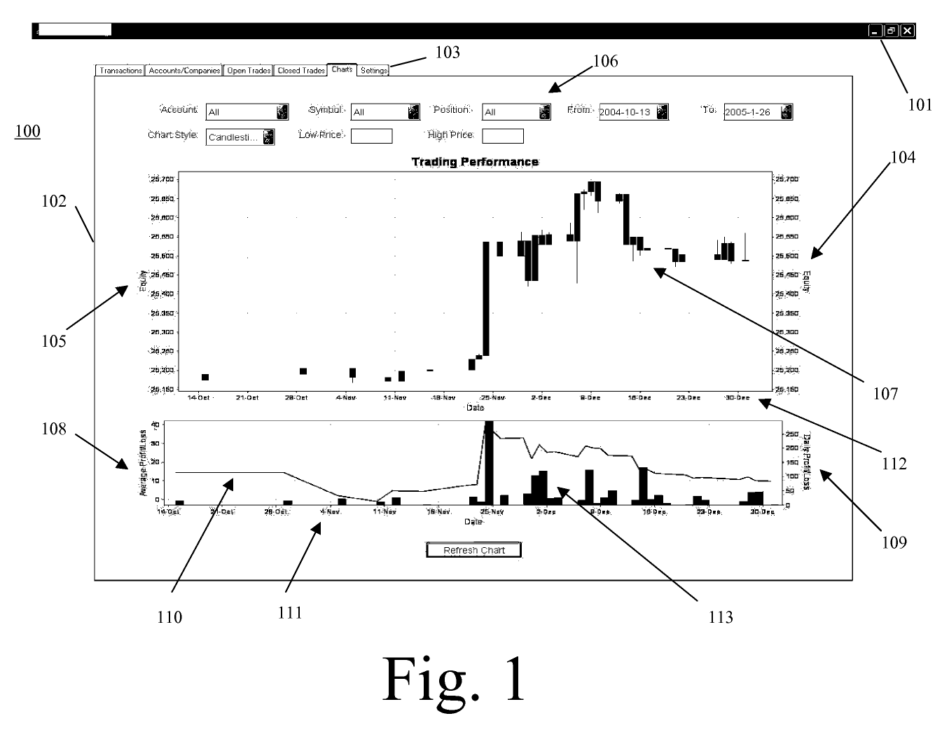

Now referring to FIG. 1 the present invention is a system and method for evaluating a security trader's performance using technical analysis. The present invention applies technical analysis to a trader's performance. The method of the present invention provides for the application of mathematically definable metrics by establishing a correspondence between an account balance and price while and at the same time creating a correspondence between volume and the total cost basis and others see page 10 sections 5-15. For a given period of time, it is possible to create progress charts 105 to which analysis tools may be applied.

A windowing system is utilized that is comprised of a header 101, main window screen shot 100. The windowing system utilizes tabbed navigation 103. A trading performance chart 102 contains a right vertical axis 104 and a left vertical axis 105 that measure the equity or value of the account or accounts. Controls 106 for chart settings and filters are provided. By manipulating the controls 106, the user may select accounts, styles and date ranges for the trading performance chart 102. The user may also filter by stock symbol, price range, and position type.

Candlestick charts 107 are also shown in the main window screen shot 100 wherein the volume chart Y-axis 108 and 109 represents daily profit/loss while the X-axis 111 represents profit/loss based on a time period such as days. A Profit/Loss average line 110, is used to represent the values. The main candlestick chart, X-axis 112, represents time based on Days via a Profit/Loss bar 113.

In the present invention, technical analysis techniques used to chart the past performance of securities are used to evaluate the past performance of a securities trader. Indicators such as volume, simple and exponential moving averages, relative strength, moving average convergence and divergence, stochastic, Fibonacci retracements, Bollinger bands, and others are traditionally applied to the analysis of a security. These indicators provide a statistically analyzed visual representation of historical trades that allow for the evaluation of performance and patterns. The ability to make these evaluations will provide objective insight to a trader's or funds performance.

This is accomplished by inputting the securities historical data related to volume and price over the course of a given time frame. After inputting this data, charts in forms such as OHLC, Candlestick, logarithmic and others are generated. These charts provide information such as support, resistance, trends and various chart patterns.

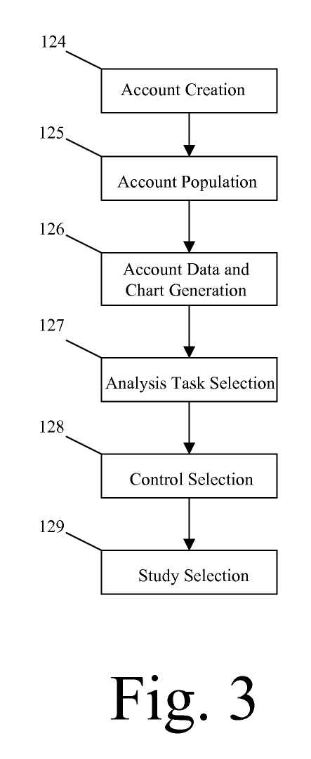

Now referring to FIG. 3, the following method is required for the system of the present invention to function properly and is illustrated as a serried of method steps. In a first step 124, a user creates a new account, in a second step 125, the user populates account with historical trading data from 1 or many equity trading accounts. In a third step 126, population of account data is automated and once populated, a user navigates to various charts via the graphical navigation system. In a fourth step, 127 by selecting from a plurality of tabs, the user may perform various analysis tasks on the account data.

In a fifth step 128, analysis tasks are initiated by selecting fields from various controls. Selectable controls include: Chart type, Date Range, Transaction Type, Price Range, Equity account selection for one or more securities. Next, the user may select among the following studies to be overlaid on the chart 129: Moving Averages, Fibonacci Retracements, Bollinger Bands, Stochastics, Relative Strength Indexing, Moving Average Convergence/Divergence, On balance Volume, and Channels

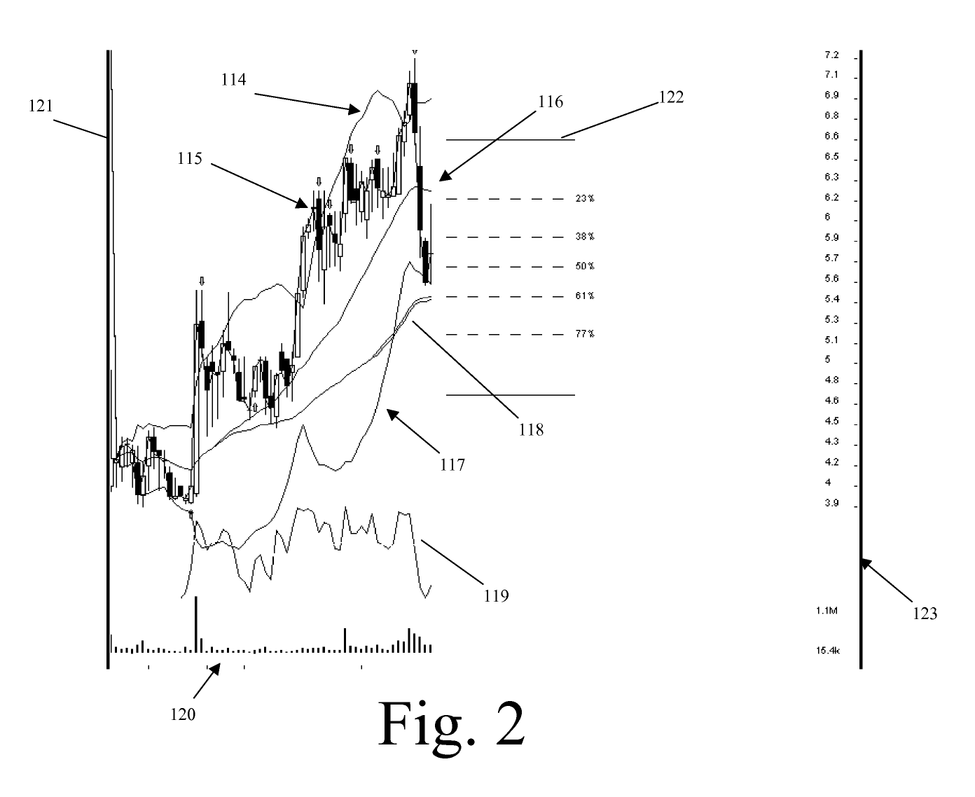

Now referring to FIG. 2, a chart illustrative of the output of the system of the present invention provides a plurality of patterns.

Bollinger Bands 114 & 117, Moving averages 115, 116 & 118, and Stochastics 119 are all illustrated in the charts as are: Volume bars 120, Disregards 121, and Fibonacci Retracement 122.

A trader's historical and current transaction history is input into the system. Once entered, the transaction data is processed. Processing involves the execution of mathematical formulae that will generate data points to be graphically represented by the software. The formulae will be associated with the technical analysis of stocks. The differentiating factor is that the formulae are being applied to a trader's metrics as opposed to an equities metrics. Where an equities price is normally used in an equation, the value of the trading account(s) is placed. Where volume is normally used in an equation, there will be a selection of metrics available for substitution. These are: total cost basis of equities traded, percentage of total account value traded, and total number of shares traded.

Once the data is processed, graphical representations will be created by the system in the form of charts. The charts may be manipulated to display the desired set of technical analysis studies which include: Simple and Exponential Moving Averages, Stochastics, Relative Strength Index, Moving Average Convergence/Divergence, Bollinger Bands, Inflection Points, Fibonacci Retracements, On Balance Volume, and Channeling.

With respect to volume, several metrics may be correlated: A trader's total transacted share volume; the percentage of a trader's capital currently invested; and the total cost basis dollar value. For example, the total amount of capital that has been used over a given period of time. When viewed as the total amount of capital invested, this aids in the determination of a trader's total amount invested in the markets at a given time. It also aids in the determination of a traders variance over time. (i.e. propensity for large swings over a short period of time)

Viewed as share volume, this can aid in determining the amount of shares being transacted over time and compared with the value of the account can provide insight as to the capitalization of the basket of equities that are being most frequently traded.

Viewed as a percentage of capital invested this aids in analyzing the frequency with which capital is turned over within a given account or accounts. This may aid in determining the potential volatility of a given trader.

These studies provide the graphical details that reveal the performance level achieved by the trader or traders being analyzed in basic forms such as ROI and basic gains/losses. In addition, repetitive patterns in areas such as propensity for overtrading, propensity for allowing oversized losses, and focus of capital on certain price ranges may be gleaned. As part of the benefit of this analysis, the user should be able to observe new pattern not previously visible while using the present invention.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method of analyzing the performance of one or many security traders over time comprising of the following:
the application of mathematically definable metrics by establishing a correspondence between an account balance and price; while at the same time creating a correspondence between volume and the total cost basis.

2. The method of analyzing the performance of one or many security traders over time of claim 1 wherein for a given period of time it is possible to create progress charts to which analysis tools may be applied.

3. The method of analyzing the performance of one or many security traders over time of claim 1 software is used that consists of:
a windowing system further comprised of
a header,
main window screen
tabbed navigation,
trading performance chart, and
controls for chart settings and filters.

4. The method of analyzing the performance of one or many security traders over time of claim 3 wherein trading performance chart contains a right vertical axis and a left vertical axis that measures the equity of one or more accounts.

5. The method of analyzing the performance of one or many security traders over time of claim 3 wherein the controls provide means for the user to select accounts, styles and date ranges for the trading performance chart.

6. The method of analyzing the performance of one or many security traders over time of claim 5 wherein the user can filter by stock symbol, price range, and position type.

7. The method of analyzing the performance of one or many security traders over time of claim 3 further consisting of candlestick charts in the main window screen shot wherein the candlestick charts Y-axis represents daily profit/loss while the X-axis represents profit/loss based on a period of time, and a Profit/Loss average line is used to represent the values.

8. The method of analyzing the performance of one or many security traders over time of claim 3 wherein technical analysis techniques used to chart the past performance of securities are used to evaluate the past performance of a securities trader including:
indicators such as volume;
simple and exponential moving averages;
relative strength;
moving average convergence and divergence;
stochastic;
Fibonacci retracements; and
Bollinger bands.

9. The method of analyzing the performance of one or many security traders over time of claim 3 wherein by inputting the securities historical data related to volume and price over the course of a given time frame, charts in forms such as OHLC, Candlestick, and logarithmic are generated.

10. The method of analyzing the performance of one or many security traders over time of claim 9 wherein the charts provide information for support, resistance, and trends.

11. A method of analyzing the performance of one or many security traders over time consisting of the following steps:
(a) a user creates a new account;
(b) the user populates account with historical trading data from 1 or many equity trading accounts;
(c) population of account data is automated and once populated, a user navigates to various charts via the tabbed navigation system;
(d) by selecting from a plurality of tabs, the user may perform various analysis tasks on the account data;
(e) analysis tasks are initiated by selecting fields from various controls; and
(f) the user may select among studies to be overlaid on the chart.

12. The method of analyzing the performance of one or many security traders over time of claim 11 wherein selectable controls include: Chart type, Date Range, Transaction Type, Price Range, and Equity account selection for one or more securities.

13. The method of analyzing the performance of one or many security traders over time of claim 11 wherein the studies include: Moving Averages, Fibonacci Retracements, Bollinger Bands, Stochastics, Relative Strength Indexing, Moving Average Convergence/Divergence, On balance Volume, and Channels.

14. The method of analyzing the performance of one or many security traders over time of claim 11 further consisting of the following steps:
(g) a trader's historical and current transaction history is inputted;
(h) the transaction data is processed.
(i) once the data is processed, graphical representations are created in the form of charts

15. The method of analyzing the performance of one or many security traders over time of claim 14 wherein the processing involves the execution of mathematical formulae that generate data points to be graphically represented.

16. The method of analyzing the performance of one or many security traders over time of claim 15 wherein the formulae are applied to a trader's metrics such that:
where an equities price is normally used in an equation, the value of the trading account(s) is placed,
where volume is normally used in an equation, a metric is substituted.

17. The method of analyzing the performance of one or many security traders over time of claim 15 wherein the selection of metrics if one of: total cost basis of equities traded, percentage of total account value traded, and total number of shares traded.

18. The method of analyzing the performance of one or many security traders over time of claim 17 wherein the charts are manipulated to display one or more of the desired set of technical analysis studies from the following group:
Simple and Exponential Moving Averages,
Stochastics,
Relative Strength Index,
Moving Average Convergence or Divergence,
Bollinger Bands,
Inflection Points,
Fibonacci Retracements,
On Balance Volume, and
Channeling.

19. The method of analyzing the performance of one or many security traders over time of claim 16 wherein the following metrics are correlated:
a trader's total transacted share volume; and
the percentage of a trader's capital currently invested; and the total cost basis dollar value.
